(19) United States
(12) Patent Application Publication
(10) Pub. No.: US 2010/0017719 A1
(43) Pub. Date: Jan. 21, 2010

(54) Conferencing system with low noise

(75) Inventors: Kenneth D. Majors, Lake Oswego, OR (US); Scott Deboy, Hillsboro, OR (US)

Correspondence Address: CHERNOFF, VILHAUER, MCCLUNG & STENZEL, LLP, 601 SW Second Avenue, Suite 1600, PORTLAND, OR, 97204-3157, US

(73) Assignee: VirtualDesign.Net, Inc.

(21) Appl. No.: 12/291,242

(22) Filed: Nov. 7, 2008

Related U.S. Application Data
(60) Provisional application No. 61/135,054, filed on Jul. 16, 2008.

(51) Int. Cl. G06F 3/048

(52) U.S. Cl. 715/727; 715/753

(57) ABSTRACT

A conferencing system with low noise.

### CROSS-REFERENCE TO RELATED APPLICATIONS

This application claims the benefit of U.S. Provisional App. No. 61/135,054, filed Jul. 16, 2008.

### BACKGROUND OF THE INVENTION

The present invention relates to a conferencing system and, more particularly, to a computer-based conferencing system enabling many users to communicate among themselves without excessive background noise.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. In addition, a conferencing system may provide file sharing enabling conferees to view and edit files, including engineering drawings and spreadsheets, that are part of the team's project.

One goal of a conferencing system is to connect a plurality of remotely located conferees and enable communication between the conferees as if the conferees were sitting at the same conference table. However, as the number of conference locations, sources of video, audio or other data input to the conference, increases, the ability of a group to communicate effectively in a conference decreases. For example, a separate transport stream, commonly comprising audio, video and textual data streams, is required for each conference location. Each of these streams are combined in some fashion and redistributed to the other members of the conference.

What is desired, therefore, is a conferencing system that enables the members of a group of participants in a conference to effectively discuss the presentation.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a conferencing system.

FIG. 2 illustrates project rooms.

FIG. 3 illustrates a conferencing server.

FIG. 4 illustrates a conferencing system.

### DETAILED DESCRIPTION OF PREFERRED EMBODIMENT

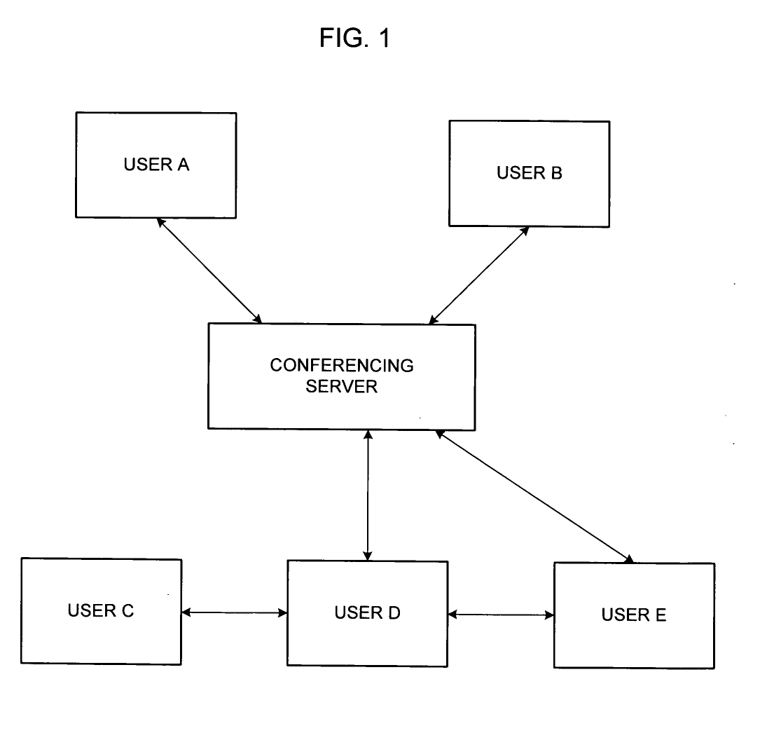

Referring to FIG. 1, a conferencing system facilitates conferencing sessions for a group of users to get together, typically using a central server, to join in a video conference. The users may use a central server and/or peer-to-peer network arrangement. In most cases, each of the users has the ability to send and receive audio and/or video and/or textual and/or other information.

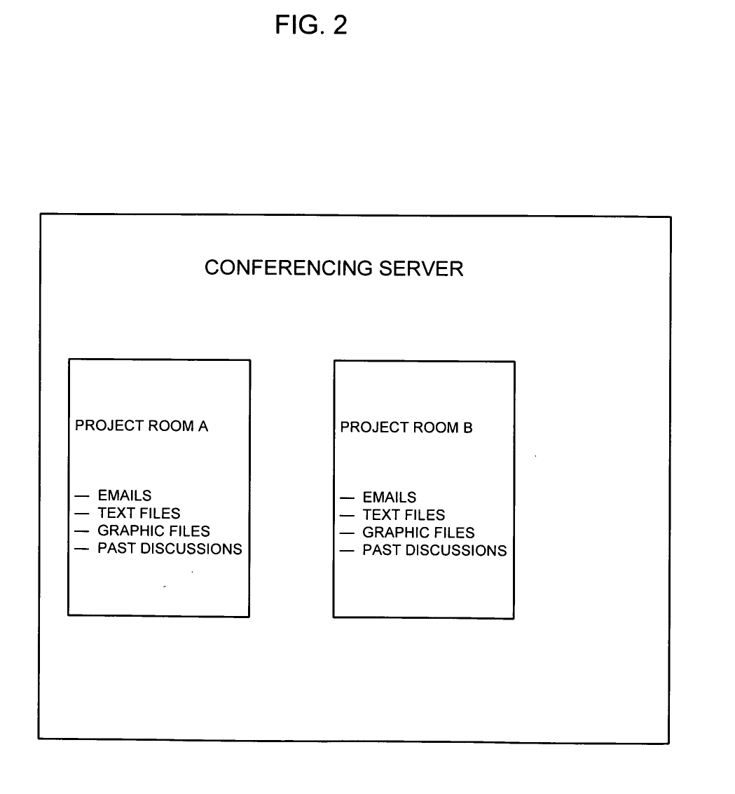

Referring to FIG. 2, the conference system may also include project rooms to which one or more users have permission to access. In each project room may be stored many documents and files relating to the project. For example, a project room may includes video conferences, e-mails, text files, graphic files, past discussions, etc., related to the project. In this manner, the different members of the project may share information related to the project.

In most situations, the conferencing server provides the ability for a group of users to have an audio conference among themselves. Typically the group is somewhat limited, such as less than 10 users, and thus two-way simultaneous audio communication is desirable. Normally the users can arbitrate among themselves as to who should be speaking at any particular time. Moreover, the communication between the different users is relatively clear, easy to understand, despite typical background noise. Unfortunately, as the number of users increase in a particular group, the background noise from each user's audio stream collectively sum together resulting in an undesirable background noise that is readily noticeable to the users in an audio stream.

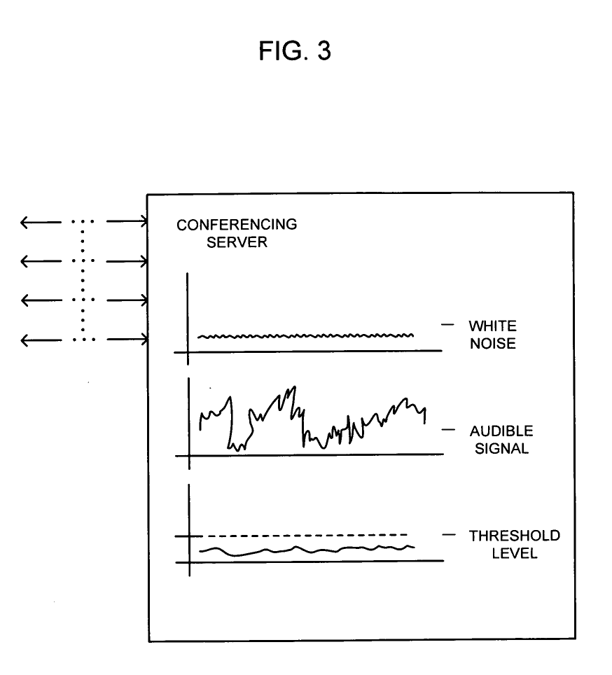

Referring to FIG. 3, the conferencing server may monitor the background noise levels from each of the users or selected groups of users. Typically, a user that is speaking provides an average signal (or other statistical measure) that is above a threshold level for a sufficient duration having particular characteristics. In this manner, the conferencing server may determine those times that the user is speaking or otherwise provide a potentially desirable audio signal. The system should provide desirable audio content to other users while at the same time attenuating or otherwise eliminating non-desirable audio signals originating from other users, such as background noise or static. In this manner, the collective signal being provided to the users from the conferencing server has reduced undesirable background noise.

The sufficient duration measure reduces the likelihood of selecting audio signals based upon erroneous signals since most speech has a substantial duration to it. In addition, the signal is also typically varying a substantial magnitude over time as the voice raises and lowers, or otherwise there are brief pauses between words, in contrast to generally white noise which lacks such characteristics. This sufficient variation in the signal magnitude may likewise be used as a criteria to identify desirable audio content. In most cases, desirable audio content is above a threshold level since it would not be anticipated that a user would whisper during a conference. Thus, the threshold level should be selected to be above a whisper level and below a typical speech level. Accordingly, using the sufficient duration, and/or substantial variation, and/or threshold level and/or other characteristics, the conferencing server may determine whether or not the audio signal from a particular user (or group of users) is voice signals or otherwise desirable content for other users to listen to. Those signals which are not desirable may be attenuated or otherwise reduced to zero (or substantially zero). In this manner, the background noise from those users which are determined to not be providing desirable audio content are reduced from being combined together when the total audio content is provided to users by the conferencing server.

In another embodiment, the system may use a threshold number of users to determine whether or not to attenuate any particular user channels. Typically for only a limited number of users, such as 2-10, there is rarely sufficient background noise to be troublesome to other users. In this case, it may be preferable from a user experience to include whatever background noise is present to the other users. This reduces the likelihood that desirable audio content will be inadvertently attenuated. In the event that the number of users is greater than a threshold number, such as more than 10 users, then the conferencing system may use a noise reduction technique, such as the signal attenuation, in order to reduce the background noise. In this manner, the system is adaptive to when it may be more likely to be desirable to include a noise reduction technique.

Typically the system measures the time that the desirable audio content starts and the time that the desirable audio content ends. In this case, the system may attenuate the audio content at the start and end times of the desirable audio content. However, selecting only this audio content may result in a somewhat choppy audio presentation to the other users. Accordingly, it is desirable to include an addition few seconds of audio content before the content indicated as desirable, and it is desirable to include an additional few seconds of audio content after the content indicated as desirable. In this manner, the system will provide a smoother transition, that has a better listening experience to users, by including additional audio content.

In a typical audio conference there tends to be a limited number of participants that engage in the majority, if not all, of the desirable audio content. This typically occurs in the case of a teacher and students, or otherwise in a discussion between a couple users while the remainder of the users tend to primarily listen. In this case, it is desirable not to attenuate (or otherwise aggressively attenuate) users that are frequently providing desirable audio content. Accordingly, the system may track the speech patterns of the users, and for those users that are frequently providing desirable audio content selective turn off the attenuation (or less change than that done to other user's signals) for those users. Thus, users which infrequently provide audio content will have their non-desirable audio content attenuated while those frequently providing desirable audio content will have their audio content not attenuated (or otherwise less attenuation than others).

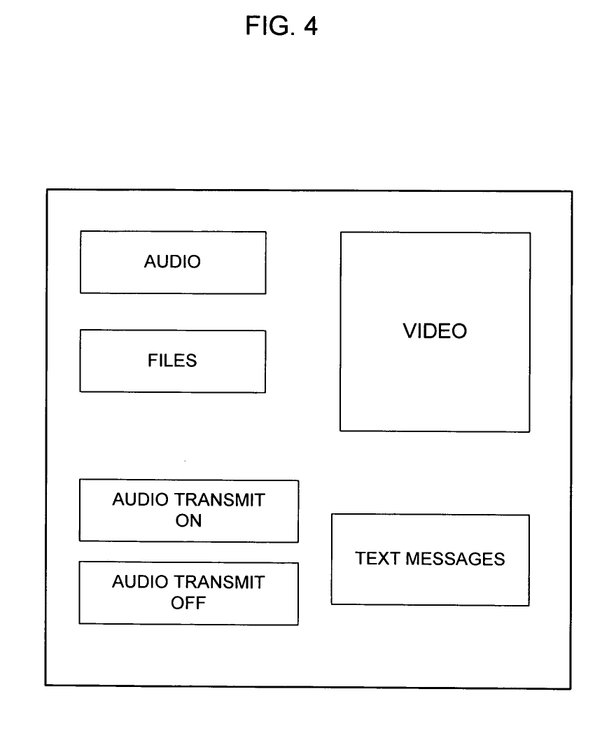

Referring to FIG. 4, the conferencing server and/or software at the user's computer may include multiple interfaces, such as for example, a window for video, a window for text messages, a window for audio messages, a window that provides files and/or navigation to desirable files and/or other windows. In addition, the interface may provide the ability to turn on (e.g., enable) audio transmission to other users, with the default having audio transmission being off. In this manner, each user will not provide background noise without an affirmative action of turning on the audio transmission. Accordingly, the user will typically select audio transmit on just prior to transmitting audio signals in a particular conference and the system will turn off audio transmit after some time period. The system may turn off the audio transmit after a sufficient time period has elapsed or otherwise after a sufficient time period since the last desirable audio transmission by the user. Otherwise, the user may manually turn off the audio transmission by selecting the audio transmit off selection (e.g., disable).

While it may be sufficient to permit the user to simply select audio transmit on, in some cases the user may have only a short comment and the audio transmission may remain on for an undesirably long time and it is unlikely the user will reliability turn the audio transmission off. Accordingly, the system may require the user to provide continuous input to the system in order to maintain the audio transmit on status. For example, the system may require the user to maintain a mouse click on the audio transmit on or otherwise maintain pressing a key on the keyboard to indicate that the user desires to continue to transmit audio. In this manner, when the user relaxes he will typically release pressing the mouse button or the key on the keyboard. This provides another semi-automatic manner of reducing the likelihood of excess audio transmission.

After the user ceases transmitting audio signals for a period of time the system may presume that the user no longer wishes to transmit audio signals. In this manner, the system may automatically revert the audio transmit on to an transmit audio off setting. This will reduce the likelihood of sending spurious audio signals.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A conferencing system that facilitates the audio communication between a plurality of different users, comprising:
(a) a plurality of projects each of which having a set of documents;
(b) a first said user providing an audio signal to a plurality of other users;
(c) a second said user providing an audio signal to said plurality of other users;
(d) a third said user providing an audio signal to said plurality of other users;
(e) said conferring system monitoring a noise level of said audio communication and selectively activating noise suppression for said conferencing system.

2. The system of claim 1 wherein said noise suppression is provided to a selected set of said audio signals.

3. The system of claim 1 wherein a sufficient duration of measure is used for said selectively activating said nose suppression.

4. The system of claim 1 wherein said selectively is based upon the number of said plurality of users.

5. The system of claim 1 wherein said selectively is based upon a start and an end time of a particular audio.

6. The system of claim 1 wherein said selectively is for a particular user.

7. The system of claim 1 wherein at least one of said plurality of users has a default setting of transmit no audio signals.

8. The system of claim 1 wherein an audio transmit for a user is automatically deselected after a sufficient time period after said user has ceased providing an audio signal.
